(19) United States
(12) Patent Application Publication
(10) Pub. No.: US 2012/0279870 A1
(43) Pub. Date: Nov. 8, 2012

(54) METHOD FOR ELECTROCHEMICAL OXYGEN REDUCTION IN ALKALINE MEDIA

(75) Inventors: Jens Assmann, Hilden (DE); Elsa Karoline Schaedlich, Leipzig (DE)

(73) Assignee: BAYER INTELLECTUAL PROPERTY GMBH, Monheim (DE)

(21) Appl. No.: 13/515,958

(22) PCT Filed: Dec. 12, 2010
(86) PCT No.: PCT/EP10/69604

§ 371 Date: Jul. 25, 2012

(30) Foreign Application Priority Data
Dec. 18, 2009 (DE) 102009058832.9

(51) Int. Cl. C25B 15/00; B01J 31/02

(52) U.S. Cl. 205/351; 502/167

(57) ABSTRACT

The invention relates to a method for electrochemical reduction of oxygen in alkaline media, a catalyst comprising nitrogen-doped carbon nanotubes (NCNTs) having nanoparticles located on their surface being used.

The invention relates to a process for the electrochemical reduction of oxygen in alkaline media using a catalyst comprising nitrogen-doped carbon nanotubes (NCNTs) having metal nanoparticles present on their surface.

Carbon nanotubes have been generally known to those skilled in the art at least since they were described in 1991 by Iijima (S. Iijima, Nature 354, 56-58, 1991). The term carbon nanotubes has since then encompassed cylindrical bodies comprising carbon and having a diameter in the range from 3 to 80 nm and a length which is a multiple of at least 10 of the diameter. A further characteristic of these carbon nanotubes is layers of ordered carbon atoms, with the carbon nanotubes generally having a core having a different morphology. Synonyms for carbon nanotubes are, for example, “carbon fibrils” or “hollow carbon fibers” or “carbon bamboos” or (in the case of wound structures) “nanoscrolls” or “nanorolls”.

Owing to their dimensions and particular properties, these carbon nanotubes are of industrial importance for the production of composites. Further important possibilities are in electronic and energy applications since they generally have a higher specific conductivity than graphitic carbon, e.g. in the form of conductive carbon black. The use of carbon nanotubes is particularly advantageous when they are very uniform in respect of the abovementioned properties (diameter, length, etc.).

It is likewise possible to dope these carbon nanotubes with heteroatoms, e.g. of main group five (for instance nitrogen), during the process for producing the carbon nanotubes.

Generally known methods of producing nitrogen-doped carbon nanotubes are based on the conventional production methods for classical carbon nanotubes, for example electric arc processes, laser ablation processes and catalytic processes.

Electric arc and laser ablation processors are, inter alia, characterized in that carbon black, amorphous carbon and fibers having high diameters are formed as by-products in these production processes, so that the resulting carbon nanotubes usually have to be subjected to complicated after-treatment steps, which makes the products obtained from these processes and thus these processes economically unattractive.

On the other hand, catalytic processes offer advantages for economical production of carbon nanotubes since a product having a high quality may be able to be produced in good yield by means of these processes.

A catalytic process of this type, in particular a fluidized-bed process, is disclosed in DE 10 2006 017 695 A 1. The process disclosed there encompasses, in particular, an advantageous mode of operation of the fluidized bed by means of which carbon nanotubes can be produced continuously with introduction of fresh catalyst and discharge of product. It is likewise disclosed that the starting materials used can comprise heteroatoms. Use of starting materials which would result in nitrogen doping of the carbon nanotubes is not disclosed.

A similar process for the targeted, advantageous production of nitrogen-doped carbon nanotubes (NCNTs) is disclosed in WO 2009/080204. In WO 2009/08204, it is disclosed that the nitrogen-doped carbon nanotubes (NCNTs) produced by means of the process can still contain residues of the catalyst material for producing them. These residues of catalyst material can be metal nanoparticles. A process for subsequent loading of the nitrogen-doped carbon nanotubes (NCNTs) is not disclosed. According to the process described in WO 2009/080204, removal of the residues of the catalyst material is further preferred.

However, according to WO 2009/080204, it is always the case that only small proportions of the catalyst material are present in the nitrogen-doped carbon nanotubes (NCNTs) obtained. The list of possible catalyst materials which can be present in small proportions in the nitrogen-doped carbon nanotubes (NCNTs) produced consists of Fe, Ni, Cu, W, V, Cr, Sn, Co, Mn and Mo, and also possibly Mg, Al, Si, Zr, Ti, and also further elements which are known to those skilled in the art and form mixed metal oxide and salts and oxides thereof. However, surface loading of the nitrogen-doped carbon nanotubes (NCNTs) with the above-mentioned catalyst materials is not disclosed since the nitrogen-doped carbon nanotubes (NCNTs) are formed on the catalyst materials.

Furthermore, WO 2009/080204 does not disclose the forms in which the nitrogen can be present in the nitrogen-doped carbon nanotubes (NCNTs).

Yan et al. in “Production of a high dispersion of silver nanoparticles on surface-functionalized multi-walled carbon nanotubes using an electrostatic technique”, Materials Letters 63 (2009) 171-173, disclose that carbon nanotubes without heteroatoms can subsequently be loaded with silver on their surface. Accordingly, carbon nanotubes can be subsequently loaded with silver by firstly being functionalized on their surface by means of oxidizing acids such as nitric acid and sulfuric acid. According to the disclosure by Yan et al., functional groups which serve as “anchor sites” for the silver nanoparticles to be deposited are formed on the surface of the carbon nanotubes during the course of their treatment with the oxidizing acids.

Since, according to Yan et al., the oxidizing property of the acids is critical, it can be assumed from the disclosure by Yan et al. that the heteroatoms are oxygen and nitrogen-doped carbon nanotubes (NCNTs) are therefore not disclosed as starting point for the carbon nanotubes loaded with silver. In addition, Yan et al. do not disclose that these loaded carbon nanotubes can be used as catalyst in the electrochemical reduction of oxygen in an alkaline medium.

WO 2008/138269 discloses nitrogen-containing carbon nanotubes which bear platinum or ruthenium metal nanoparticles and have a proportion of nitrogen of from 0.01 to 1.34, expressed as the ratio of nitrogen to carbon (CNₓ where x=0.01-1.34). According to WO 2008/138269, the platinum or ruthenium metal nanoparticles have a diameter of from 0.1 to 15 nm and are present in a proportion of from 1 to 100% of the total mass of the nitrogen-containing carbon nanotubes.

WO 2008/138269 does not disclose that metal nanoparticles other than those of platinum or of ruthenium can be present. Furthermore, WO 2008/138269 also does not disclose the nature of the nitrogen in the nitrogen-containing carbon nanotubes and also does not disclose that the resulting nitrogen-containing carbon nanotubes loaded with platinum or ruthenium metal nanoparticles can be used in processes for the electrochemical reduction of oxygen in an alkaline medium.

The German patent application number DE 10 2008 063 727 describes a process for the reduction of molecular oxygen in alkaline media, which allows the electro-chemical reduction of molecular oxygen to doubly negatively charged oxygen ions in solutions having a pH greater than or equal to 8 and in which the molecular oxygen is brought into contact in such solutions with nitrogen-doped carbon nanotubes (NCNTs) having a proportion of pyridinic and quaternary nitrogen.

It can be seen from DE 10 2008 063 727 and from further documents of the prior art described in that application that the use of nitrogen-doped carbon nanotubes (NCNTs) in connection with the reduction of oxygen may allow an industrially advantageous reduction of oxygen. However, the associated technical problems do not yet appear to be completely understood and/or to have been solved.

However, DE 10 2008 063 727 does not disclose a process for the reduction of oxygen in alkaline media in the presence of nitrogen-doped carbon nanotubes (NCNTs), in which these nitrogen-doped carbon nanotubes (NCNTs) can be loaded with metal nanoparticles on their surface.

According to the prior art, provision of a particularly effective process for the electrochemical reduction of oxygen which fully exploits the advantages of nitrogen-doped carbon nanotubes (NCNTs) is therefore an unsolved problem.

It has now surprisingly been found that, as a first subject of the present invention, that this problem can be solved by a process for the electrochemical reduction of oxygen in alkaline media having a pH of more than 10, characterized in that it is carried out in the presence of a catalyst comprising nitrogen-doped carbon nanotubes (NCNTs) comprising metal nanoparticles having an average particle size in the range from 1 to 15 nm present in a proportion of from 2 to 60% by weight on their surface.

The nitrogen-doped carbon nanotubes (NCNTs) used as constituent of the catalyst in the process of the invention usually have a proportion of nitrogen of at least 0.5% by weight. The nitrogen-doped carbon nanotubes (NCNTs) used preferably have a proportion of nitrogen in the range from 0.5% by weight to 18% by weight, particularly preferably in the range from 1% by weight to 16% by weight.

The nitrogen present in the nitrogen-doped carbon nanotubes (NCNTs) used as constituent of the catalyst in the process of the invention is incorporated in the graphitic layers of the nitrogen-doped carbon nanotubes (NCNTs) and is preferably at least partly present as pyridinic nitrogen therein.

However, the nitrogen present in the nitrogen-doped carbon nanotubes (NCNTs) can also be additionally present as nitro nitrogen and/or nitroso nitrogen and/or pyrrolic nitrogen and/or amine nitrogen and/or quaternary nitrogen.

The proportions of quaternary nitrogen and/or nitro and/or nitroso and/or amine and/or pyrrolic nitrogen are of subordinate importance to the present invention since their presence does not significantly hinder the invention.

However, the process is particularly preferably carried out using catalysts comprising nitrogen-doped carbon nanotubes (NCNTs) in which at least 40 mol % of the nitrogen present is pyridinic nitrogen.

The proportion of pyridinic nitrogen in the nitrogen-doped carbon nanotubes (NCNTs) of the catalyst is very particularly preferably at least 50 mol %.

In the context of the present invention, the term “pyridinic nitrogen” describes nitrogen atoms which are present in a heterocyclic compound consisting of 5 carbon atoms and the nitrogen atom in the nitrogen-doped carbon nanotubes (NCNTs). An example of such a pyridinic nitrogen is shown in figure (I) below.

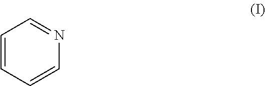

However, the term pyridinic nitrogen refers not only to the aromatic form of the abovementioned heterocyclic compound shown in figure (I) but also the singly or multiply saturated compounds of the same empirical formula.

Furthermore, other compounds are also encompassed by the term “pyridinic nitrogen” when such other compounds comprise a heterocyclic compound consisting of five carbon atoms and the nitrogen atom. An example of such pyridinic nitrogen is shown in figure (II).

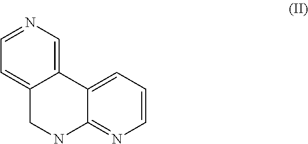

Figure (II) depicts by way of example three pyridinic nitrogen atoms which are constituents of a multicyclic compound. One of the pyridinic nitrogen atoms is a constituent of a nonaromatic heterocyclic compound.

In contrast thereto, the term “quaternary nitrogen” as used in the context of the present invention refers to nitrogen atoms which are covalently bound to at least three carbon atoms. For example, such quaternary nitrogen can be a constituent of multicyclic compounds as shown in figure (III).

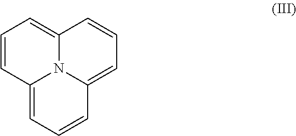

The term pyrrolic nitrogen describes, in the context of the present invention, nitrogen atoms which are present in a heterocyclic compound consisting of four carbon atoms and the nitrogen in the nitrogen-doped carbon nanotubes (NCNTs). An example of a pyrrolic compound in the context of the present invention is shown in figure (IV):

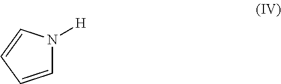

In the context of “pyrrolic nitrogen”, too, this is not restricted to the heterocyclically unsaturated compound shown in figure (IV) but saturated compounds having four carbon atoms and one nitrogen atom in a cyclic arrangement are also encompassed by the term in the context of the present invention.

For the purposes of the present invention, the term nitro or nitroso nitrogen refers to nitrogen atoms in the nitrogen-doped carbon nanotubes (NCNTs) which are, regardless of their further covalent bonds, bound to at least one oxygen atom. A specific form of such a nitro or nitroso nitrogen is shown in figure (V), which illustrates, in particular, the difference from the abovementioned pyridinic nitrogen.

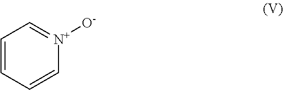

It can be seen from figure (V) that, in contrast to compounds which comprise a “pyridinic nitrogen” in the sense of the present invention, the nitrogen here is also covalently bound to at least one oxygen atom. The heterocyclic compound thus no longer consists only of five carbon atoms and the nitrogen atom but instead consists of five carbon atoms, the nitrogen atom and an oxygen atom.

Apart from the compound shown in figure (V), the term nitro or nitroso nitrogen also encompasses, in the context of the present invention, the compounds which consist of only nitrogen and oxygen. The form of nitro or nitroso nitrogen shown in figure (V) is also referred to as oxidized pyridinic nitrogen.

In the context of the present invention, the term amine nitrogen refers to nitrogen atoms which, in the nitrogen-doped carbon nanotubes (NCNTs), are bound to at least two hydrogen atoms and to not more than one carbon atom but are not bound to oxygen.

The presence of pyridinic nitrogen in the proportions indicated is particularly advantageous because it has surprisingly been found that the pyridinic nitrogen in particular of the nitrogen-doped carbon nanotubes (NCNTs) of the catalyst used acts synergistically with the metal nanoparticles present on the surface of the nitrogen-doped carbon nanotubes (NCNTs) to catalyze the electrochemical reduction of oxygen in an alkaline medium.

Without wishing to be tied to a theory, it appears that a molecular interaction between the pyridinic nitrogen groups of the nitrogen-doped carbon nanotubes (NCNTs) and the metal nanoparticles on the surface of the nanotubes catalyzes the reduction of oxygen in the process more strongly than would have been expected.

That molecular interaction in particular may well lead to the advantageous use of the nitrogen-doped carbon nanotubes (NCNTs) bearing metal nanoparticles compared to the pure metal nanoparticles or pure nitrogen-doped carbon nanotubes (NCNTs) as improved catalysts.

The metal nanoparticles can consist of a metal selected from the group consisting of Fe, Ni, Cu, W, V, Cr, Sn, Co, Mn, Mo, Mg, Al, Si, Zr, Ti, Ru, Pt, Ag, Au, Pd, Rh, Ir, Ta, Nb, Zn and Cd.

The metal nanoparticles preferably consist of a metal selected from the group consisting of Ru, Pt, Ag, Au, Pd, Rh, Ir, Ta, Nb, Zn and Cd.

The metal nanoparticles particularly preferably consist of a metal selected from the group consisting of Ag, Au, Pd, Pt, Rh, Ir, Ta, Nb, Zn and Cd.

The metal nanoparticles very particularly preferably consist of silver (Ag).

The average particle size of the metal nanoparticles is preferably in the range from 2 to 5 nm.

The proportion of metal nanoparticles on the catalyst comprising nitrogen-doped carbon nanotubes (NCNTs) bearing metal nanoparticles is preferably from 20 to 50% by weight.

The catalyst which comprises nitrogen-doped carbon nanotubes (NCNTs) comprising metal nanoparticles having an average particle size in the range from 1 to 15 nm present in a proportion of from 2 to 60% by weight on their surface and is used in the process of the invention is usually obtained by a process which is characterized in that it comprises at least the steps:
a) provision of nitrogen-doped carbon nanotubes (NCNTs) having a proportion of at least 0.5% by weight of nitrogen as suspension (A) in a first solvent,
b) provision of a suspension (B) of metal nanoparticles in a second solvent,
c) mixing of the suspensions (A) and (B) to give a suspension (C) and
d) separation of the nitrogen-doped carbon nanotubes (NCNTs) now loaded with metal nanoparticles from the suspension (C).

The nitrogen-doped carbon nanotubes (NCNTs) used in step a) of the process of the invention are usually ones as can be obtained from the process described in WO 2009/080204.

In a first preferred embodiment of the process, these are nitrogen-doped carbon nanotubes (NCNTs) having a proportion of nitrogen in the range from 0.5% by weight to 18% by weight. They are preferably nitrogen-doped carbon nanotubes (NCNTs) having a proportion of nitrogen in the range from 1% by weight to 16% by weight.

In a second preferred embodiment of the process, they are nitrogen-doped carbon nanotubes (NCNTs) having a proportion of pyridinic nitrogen of at least 40 mol %, preferably at least 50 mol %, of nitrogen present in the nitrogen-doped carbon nanotubes (NCNTs).

The suspension (B) as per step b) of the process is usually obtained by providing a solvent (A) containing a metal salt in a step b1) and subsequently reducing the metal salt in the solvent (A) to metal nanoparticles so as to give a suspension (B) in a step b2).

This reduction of the metal salt in the solvent (A) can occur in the presence or absence of colloid stabilizers which prevent agglomeration of the metal nanoparticles being formed. The reduction is preferably carried out in the presence of such colloid stabilizers.

Suitable colloid stabilizers are usually those selected from the group consisting of amines, carboxylic acids, thiols, dicarboxylic acids, the salts of the above and sulfoxides.

Preference is given to those selected from the group consisting of butylamine, decanoic acid, dodecylamine, myristic acid, dimethyl sulfoxide (DMSO), ortho-toluene thiol and sodium citrate.

The metal salt in the solvent (A) as per step b1) is usually a solution of a salt of one of the metals selected from the group consisting of Fe, Ni, Cu, W, V, Cr, Sn, Co, Mn, Mo, Mg, Al, Si, Zr, Ti, Ru, Pt, Ag, Au, Pd, Rh, Ir, Ta, Nb, Zn and Cd.

The metals are preferably selected from the group consisting of Ru, Pt, Ag, Au, Pd, Rh, Ir, Ta, Nb, Zn and Cd. The metals are particularly preferably selected from the group consisting of Ag, Au, Pd, Pt, Rh, Ir, Ta, Nb, Zn and Cd. The metal is very particularly preferably silver (Ag).

The metal salts are usually salts of the abovementioned metals with a compound selected from the group consisting of nitrate, acetate, chloride, bromide, iodide, sulfate. Preference is given to chloride or nitrate.

The metal salts are usually present in a concentration of from 1 to 1000 mmol/l in the solvent (A).

The solvents (A) are usually selected from the group consisting of water, alcohols, toluene, cyclohexane, pentane, hexane, heptane, octane, benzene, xylenes and mixtures thereof.

Alcohols from the above list can be monohydric or polyhydric alcohols. Possible examples of polyhydric alcohols are ethylene glycol, glycerol, sorbitol and inositol. Polyhydric alcohols can also be polymeric alcohols such as polyethylene glycol.

The reduction in step b2) of the process is usually carried out using a chemical reducing agent (R) selected from the group consisting of sodium borohydride, hydrazine, sodium citrate, ethylene glycol, methanol, ethanol and further borohydrides.

In a step b3) carried out in a preferred further development of the process for producing the catalyst, the liquid (essentially the solvent from steps b1) and b2)) is separated off from the metal nanoparticles formed and the metal nanoparticles are subsequently taken up in the second solvent indicated in step b) of the process.

If the above-described preferred further development of the process for producing the catalyst is not carried out, the liquid mentioned above forms the second solvent.

The first and second solvents in steps a) and b) of the process for producing the catalyst can be selected independently from the group consisting of water, alcohols, toluene, cyclohexane, pentane, hexane, heptanes, octane, benzene, xylenes and mixtures thereof.

Alcohols from the above list can be monohydric or polyhydric alcohols. Possible examples of polyhydric alcohols are ethylene glycol, glycerol sorbitol and inositol.

Polyhydric alcohols can also be polymeric alcohols such as polyethylene glycol.

The first solvent and the second solvent are preferably at least partially identical.

The separation in step d) of the process is usually carried out using methods as are generally known to those skilled in the art. A nonexclusive example of such a separation is filtration.

The present invention further provides for the use of nitrogen-doped carbon nanotubes (NCNTs) loaded with metal nanoparticles on their surface for the electrochemical reduction of oxygen in alkaline media having a pH of more than 10.

The advantages of this use have been presented above in connection with the process of the invention. The preferred variants of the process which are described there can likewise be used in the use according to the invention.

The process of the invention and the catalysts comprising nitrogen-doped carbon nanotubes (NCNTs) comprising metal nanoparticles which are produced for the process are illustrated below with the aid of some examples, but the examples should not be construed as restricting the scope of the invention.

In addition, the invention is illustrated with the aid of figures, without being restricted thereto.

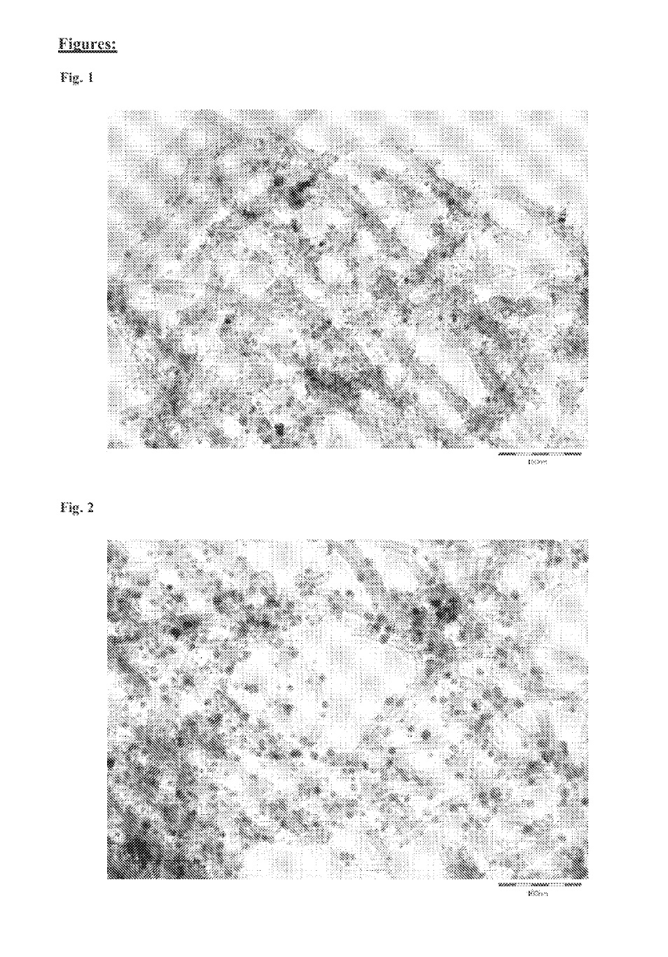

FIG. 1 shows the result of the TEM examination of the catalyst as per example 1 from example 6.

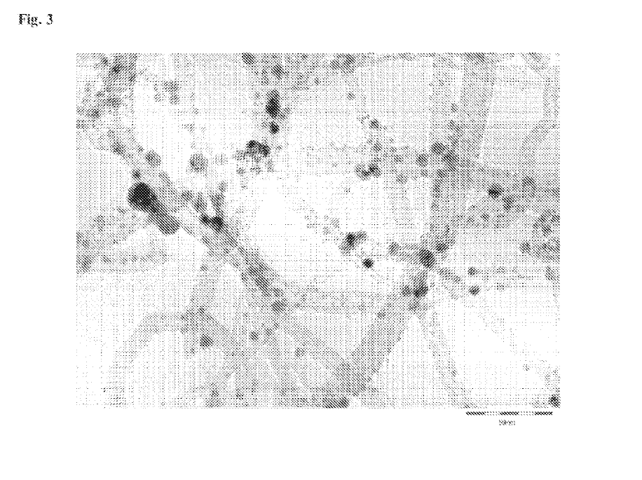

FIG. 2 shows the result of the TEM examination of the catalyst as per example 2 from example 6.

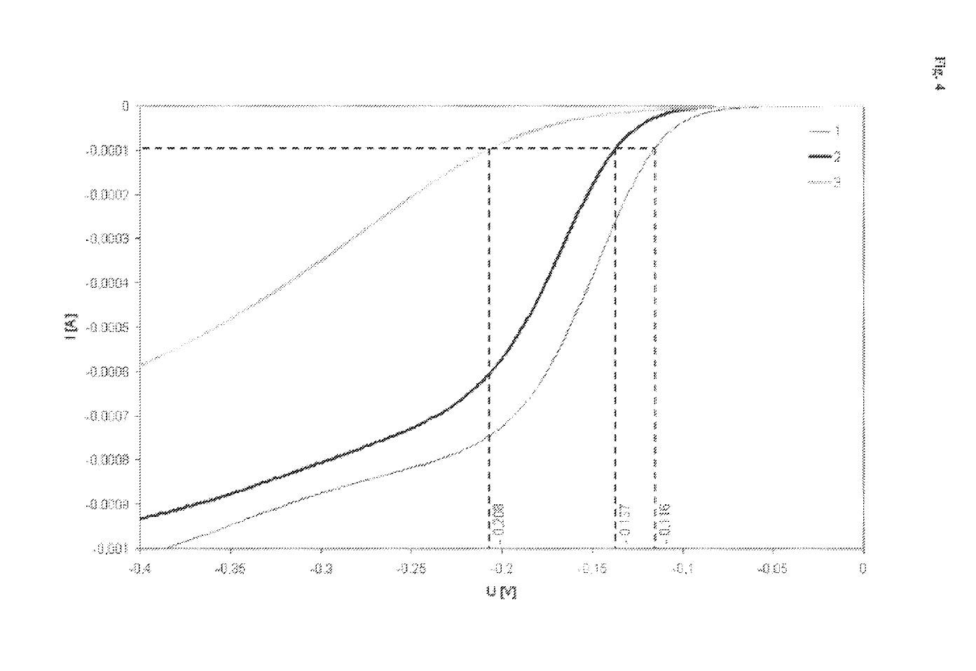

FIG. 3 shows the result of the TEM examination of the catalyst as per example 3 from example 6.

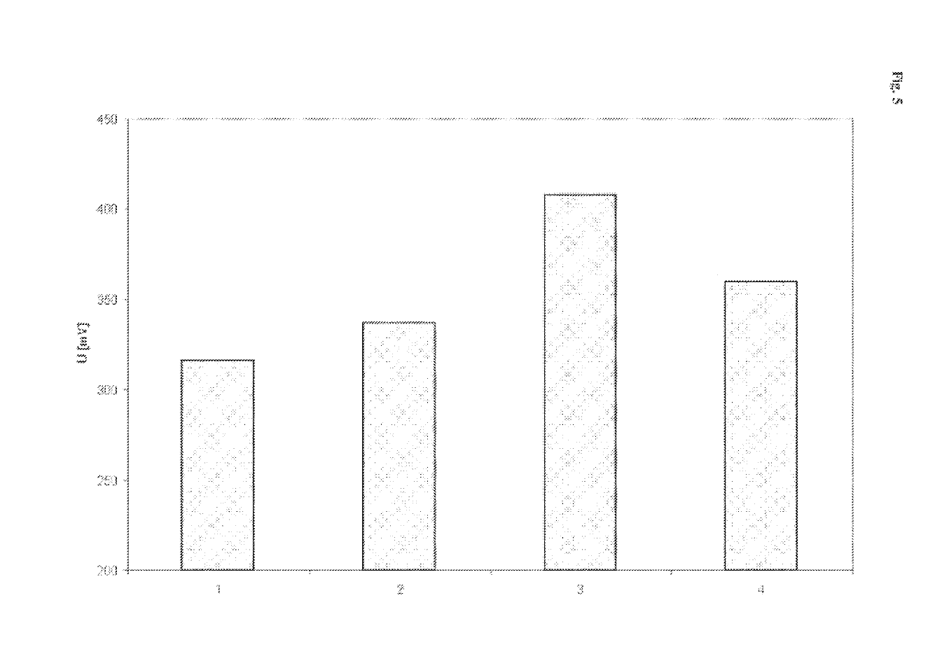

FIG. 4 shows the results of the measurements of the process using the catalysts from examples 1 to 3 as per examples 7 and 8. The curve of the reduction current (I) versus the applied voltage (U) relative to an Ag/AgCl reference electrode is shown, and also the voltage on the x axis at a reduction current of in each case −10⁴ A.

FIG. 5 shows a comparison of the overvoltages (U) for the reduction of one mole of oxygen for the processes (1-2) according to the invention using the catalysts as per examples 1 and 2 compared to the processes (3-4) which are not according to the invention using the catalysts as per examples 3 and 4.

### EXAMPLES

### Example 1

### Production of a Catalyst which can be Used in the Process of the Invention

Nitrogen-doped carbon nanotubes were produced as described in example 5 of WO 2009/080204 with the only differences that pyridine was used as starting material, the reaction was carried out as a reaction temperature of 700° C. and the reaction time was restricted to 30 minutes.

Residual amounts of the catalyst used (a catalyst was prepared as described in example 1 of WO 2009/080204 and used) were removed by washing the nitrogen-doped carbon nanotubes obtained in 2 molar hydrochloric acid for 3 hours under reflux.

Some of the nitrogen-doped carbon nanotubes obtained were subjected to the examination as per example 5. An amount of 800 mg of the nitrogen-doped carbon nanotubes were introduced into 100 ml of cyclohexane and treated with ultrasound for 15 minutes (ultrasonic bath, 35 kHz).

A suspension of silver nanoparticles was obtained by firstly dissolving 22.7 g (131.4 mmol) of decanoic acid (>99%, Acros Organics) and 30 g (131.4 mmol) of myristic acid (>98%, Fluka) in 500 ml of toluene (>99.9%, Merck). 22.3 g (131.4 mmol) of silver nitrate (>99%, Roth) dissolved in 25 ml of deionized water were added thereto. After the addition, the mixture was stirred for 5 minutes.

19.2 g (263 mmol) of n-butylamine (>99.5%, Sigma-Aldrich) were subsequently added dropwise over a period of three minutes while stirring. 1.24 g (32.9 mmol) of sodium borohydride (>98%, Acros Organics) which had previously been dissolved in 40 ml of ice-cooled deionized water were then added to the reaction mixture over a period of 15 minutes while stirring.

After continuing to stir at room temperature for four hours, a 7-fold excess of acetone (>99.9%, Kraemer & Martin GmbH) based on the volume of toluene used was added, resulting in precipitation of a solid from the solution, with the solid subsequently being filtered off.

The moist, filtered solid obtained was washed with acetone and dried at about 50° C. in a vacuum drying oven (pressure ˜10 mbar) for two hours.

About 200 mg of the dry solid were dispersed in 30 ml of cyclohexane and this dispersion was then combined with 100 ml of the above-described dispersion of the nitrogen-doped carbon nanotubes.

The mixture formed was stirred until the dispersion medium had become completely decolorized (<2 h).

The mixture was subsequently filtered (Blue Band round filter, Schleicher&Schüll) and the catalyst obtained as filter cake was washed with acetone and again dried at 50° C. in a vacuum drying oven (pressure ˜10 mbar) for two hours.

The quantitative elemental analysis (inductively coupled plasma optical emission spectroscopy “ICP-OES”, instrument: Spectroflame D5140, from Spectro, method according to the manufacturer's instructions) subsequently carried out to determine the silver content indicated a loading of 19.0% by weight.

The catalyst obtained was subsequently partly passed to the examination as per example 6 and partly to example 7.

### Example 2

### Production of a Catalyst which can be Used in the Process of the Invention

Nitrogen-doped carbon nanotubes were produced in a manner analogous to example 1 with the sole difference that the reaction was now carried out for 60 minutes.

The nitrogen-doped carbon nanotubes were likewise partly passed to the examination as described in example 5 before mixing with a silver nanoparticle dispersion.

This was once again followed by a treatment the same as that in example 1 for applying silver nanoparticles. Quantitative elemental analysis (ICP-OES) for silver indicated a loading of 20.6% by weight.

The catalyst obtained was subsequently passed both partly to the examination as per example 6 and partly to example 7.

### Example 3

### Production of a Catalyst which Cannot be Used in the Process of the Invention

An experiment as described in example 1 was carried out with the sole difference that commercial carbon nanotubes (BayTubes®, from BayTubes) were now used instead of the nitrogen-doped carbon nanotubes used there.

An examination as described in example 5 was not carried out due to the lack of nitrogen constituents in the commercial carbon nanotubes.

Quantitative elemental analysis (TCP-OES) for silver indicated a loading of 20.6% by weight.

The catalyst obtained was subsequently passed both partly to the examination as per example 6 and partly to example 8.

### Example 4

### Production of a Further Catalyst which Cannot be Used in the Process of the Invention

Nitrogen-doped carbon nanotubes were produced in a manner analogous to example 1. In contrast to example 1, these were not subsequently loaded with silver nanoparticles. The catalyst obtained in this way was passed to example 8.

### Example 5

### X-Ray Photoelectron Spectroscopic Analysis (ESCA) of the Catalysts from Example 1 and Example 2

The proportion by mass of nitrogen in the nitrogen-doped carbon nanotubes and also the molar proportion of various nitrogen species in the proportion by mass of nitrogen found in the nitrogen-doped carbon nanotubes were determined for the nitrogen-doped carbon nanotubes as obtained in the course of example 1 and of example 2 by means of X-ray photoelectron spectroscopic analysis (ESCA; instrument: ThermoFisher, ESCALab 2201XL; method: according to the manufacturer's instructions). The values determined are summarized in table 1.

| | Measured values as per example 5 | | | | | | | |
|---|---|---|---|---|---|---|---|---|
| | | | | | | | Pyridine | |
| | N content | | | | | | (oxidized) | |
| | [% by | Pyridine N | Amine N | Pyrrole N | Quaternary N | Quaternary N | N⁺—O | NOₓ |
| Sample | weight] | [mol %] | [mol %] | [mol %] | [mol %] | [mol %] | [mol %] | [mol %] |
| Ex. 1 | 6.1 | 51.4 | 0 | 21.8 | 11.3 | 8.4 | 4.4 | 2.7 |
| Ex. 2 | 9.9 | 42.6 | 0 | 13.5 | 27.2 | 6.7 | 6.6 | 3.4 |

### Example 6

### Transmission Electron Microscopic (TEM) Examination of the Catalysts as Per Example 1, Example 2 and Example 3

The catalysts obtained as described in examples 1 to 3 were subsequently optically examined for their loading with silver under a transmission electron microscope (TEM. Philips TECNAI 20, with 200 kV acceleration voltage).

The catalysts as per example 1 and example 2 are shown in FIGS. 1 and 2, respectively. FIG. 3 shows a transmission electron micrograph of a catalyst as per example 3. All three figures confirm the high silver loading of about 20% by weight determined by means of elemental analysis.

As a result of the use of additives for stabilizing the silver nanoparticles during the synthesis, agglomeration of the silver was generally prevented and the average silver particle size is less than 10 nm after application to the nitrogen-doped and undoped carbon nanoparticles for all three examples.

The differences in the activity for the electrochemical reduction of oxygen determined in examples 7 and 8 and shown in FIG. 4 can thus be attributed to synergistic effects between the carbon support material and the silver nanoparticles. The silver loading or silver particle size, on the other hand, can thus be ruled out as cause of the differing activity.

### Example 7

### Process According to the Invention Using Catalysts from Examples 1 and 2

80 mg of the catalysts from example 1 or example 2 were firstly dispersed in 50 ml of acetone and 20 μl of this dispersion were in each case dripped onto a polished electrode surface of a rotating annular disk electrode (from Jaissle Elektronik GmbH).

After evaporation of the acetone, about 10 μl of a saturated polyvinyl alcohol solution was dripped on to fix the solid.

The rotating annular disk electrode, now comprising the catalysts as per example 1 or example 2 was then used as working electrode in a laboratory cell containing 3 electrodes (working electrode, counterelectrode and reference electrode).

The arrangement used is generally known as a three-electrode arrangement to those skilled in the art. A 1 molar NaOH solution in water which had been saturated with oxygen beforehand by passing a gas stream of pure oxygen through it was used as electrolyte surrounding the working electrode.

A commercial Ag/AgCl electrode (from Mettler-Toledo) was used as reference electrode.

The electrolyte was maintained at 25° C. The reduction of the oxygen dissolved molecularly in the electrolyte was likewise carried out at this temperature, which was controlled.

A potential difference between the working electrode and the reference electrode in the range from +0.14 V to −0.96 V was then set and the reduction current curve was then measured. The abovementioned range from +0.14 V to −0.96 V was measured at a speed of 5 mV/s.

The speed of rotation of the annular disk electrode was 3600 rpm.

To determine the advantageous nature of a process carried out according to the invention for reducing oxygen in alkaline media, the potential difference between working electrode and reference electrode at a current of 10⁴ A was in each case read off from the graphs recorded by means of the above measurement. A graph for the measurements relating to the process according to the invention using the catalysts from examples 1, 2 and 3 is shown in FIG. 4.

It can be seen that the potential difference between reference electrode and working electrode when using the catalyst as per example 1 is about −0.116 V and that when using the catalyst as per example 2 is about −0.137 V and in the case of the process which is not according to the invention using the catalyst as per example 3 is about −0.208 V when the respective potential difference is read off at a current of 10⁴ A.

All results obtained in this way for the experiments of examples 7 and 8 are summarized once more in FIG. 5 as overvoltages relative to an Ag/AgCl reference electrode in 1 N NaOH under standard conditions (23° C., 1013 hPa) to be overcome in the respective processes.

It can be seen in FIG. 5 that a potential difference of (−) 0.116 V or (−) 0.137 V prevails in the process according to the invention. This means that, in the process of the invention, only an overvoltage of 0.316 V or 0.337 V (assuming a redox potential of oxygen of 0.2 V relative to an Ag/AgCl reference electrode) prevails, so that only this has to be overcome in order to achieve flow of current and thus reduction of oxygen. In contrast, an overvoltage of 0.408 V or 0.36 V has to be overcome in the processes which are not according to the invention. Merely a reduced energy consumption per mole of reduced oxygen is therefore required in the processes according to the invention.

### Example 8

### Process which is not According to the Invention Using Catalysts from Examples 3 and 4

An experiment identical to that in example 7 was carried out with the sole difference that the catalysts as per examples 3 and 4 were used. The result of the process which is not according to the invention is, as described above for example 7, also shown for the catalyst as per example 3 in FIG. 4. The result from the process which is not according to the invention using the catalyst as per example 4 is, for reasons of clarity, no longer shown in FIG. 4. The summarized experimental data for examples 7 and 8 are shown in FIG. 5. It can be seen that, as shown above in the course of the discussion of example 7, that the processes which are not according to the invention have a higher energy consumption for the reduction of oxygen as a consequence.

1. A process for electrochemical reduction of oxygen in alkaline media having a pH of at least 10, comprising carrying out said process in the presence of a catalyst comprising nitrogen-doped carbon nanotubes NCNTs comprising metal nanoparticles having an average particle size in the range from 1 to 15 nm present in a proportion of from 2 to 60% by weight on a surface thereof.

2. The process as claimed in claim 1, wherein said nitrogen-doped carbon nanotubes NCNTs have a proportion of nitrogen of at least 0.5% by weight.

3. The process as claimed in claim 1, wherein said nitrogen in the nitrogen-doped carbon nanotubes NCNTs is at least partly present as pyridinic nitrogen.

4. The process as claimed in claim 3, wherein at least 40 mol % of said nitrogen is pyridinic nitrogen.

5. The process as claimed in claim 1, wherein said metal nanoparticles comprise a metal selected from the group consisting of Fe, Ni, Cu, W, V, Cr, Sn, Co, Mn, Mo, Mg, Al, Si, Zr, Ti, Ru, Pt, Ag, Au, Pd, Rh, Ir, Ta, Nb, Zn and Cd.

6. The process as claimed in claim 5, wherein said metal nanoparticles comprise silver Ag.

7. A process for producing a catalyst for use in the process as claimed in claim 1, wherein said process comprises at least:
a) providing nitrogen-doped carbon nanotubes NCNTs having a proportion of at least 0.5% by weight of nitrogen as suspension (A) in a first solvent,
b) providing a suspension (B) of metal nanoparticles in a second solvent,
c) mixing the suspensions (A) and (B) to give a suspension (C) and
d) separating nitrogen-doped carbon nanotubes NCNTs now loaded with metal nanoparticles from the suspension (C).

8. The process as claimed in claim 7, wherein said suspension (B) is obtained by
b1) providing a solvent (A) comprising a metal salt
b2) subsequently reducing the metal salt in the solvent (A) to metal nanoparticles to give a suspension (B).

9. The process as claimed in claim 7, wherein said first solvent and said second solvent as per steps a) and b) of said process are at least one selected independently from the group consisting of water, alcohols, toluene, cyclohexane, pentane, hexane, heptane, octane, benzene, and xylenes.

10. A nitrogen-doped carbon nanotube NCNT loaded with metal nanoparticles on a surface thereof and capable of being used for electrochemical reduction of oxygen in alkaline media having a pH of at least 10.
